(19) United States
(12) Patent Application Publication
(10) Pub. No.: US 2017/0133976 A1
(43) Pub. Date: May 11, 2017

(54) System for Mounting Solar Panels

(71) Applicant: Don Dickey, San Antonio, TX (US)

(72) Inventor: Don Dickey, San Antonio, TX (US)

(21) Appl. No.: 15/252,518

(22) Filed: Aug. 31, 2016

Related U.S. Application Data
(60) Provisional application No. 62/212,263, filed on Aug. 31, 2015.

(51) Int. Cl. H02S 30/00; H02S 20/10; H02S 20/23

(52) U.S. Cl. CPC H02S 30/00; H02S 20/23; H02S 20/10

(57) ABSTRACT

A solar panel mounting system including a first bracket having a base, a width, a partially cylindrical surface spaced a distance from the base, and a cylindrical surface between the partially cylindrical surface and the base; and a second bracket having a first leg, a second leg spaced a distance from the first leg, and a base connecting the first leg and the second leg, the base and legs together defining a first volume having a width greater than and corresponding to the width of the first bracket, a stem connected to the base and extending away from the first volume, and a bar connected to the stem and having a first planar surface and second planar surface defining first and second panel receiving volumes.

### CROSS REFERENCES TO RELATED APPLICATIONS

This original nonprovisional application claims priority to and the benefit of U.S. provisional application Ser. No. 62/212,263 (filed Aug. 31, 2015), entitled “System for Mounting Solar Panels” and which is incorporated by reference.

### FEDERALLY-SPONSORED RESEARCH

Not applicable.

### BACKGROUND OF THE INVENTION

1. Field of the Invention

This invention relates generally to solar panels. More specifically, this invention is a system for mounting solar panels in a useful position, such as on a rooftop or in a field.

2. Description of the Related Art.

With the continual rise in conventional energy costs, solar panels are becoming more popular in residential settings. Typically, residential systems involve the use of a number of solar panels interconnected and mounted to a rooftop, and can cover many thousands of square feet. Because typical systems operate at above 400 VDC, residential codes often require that each panel of the system, as well as the mounting equipment, be grounded.

Such arrays require a sufficiently strong mounting system to support not only the weight of the array, but to also provide sufficient resistance to wind forces. Tightly spaced panels effectively form a large surface area, which could result in damage to the panels, the mounting system, or both, under strong wind conditions. In addition, these systems must accommodate a range of surface types and conditions, including grassy fields, bare earth, cement slabs, and gravel or crushed rock.

Most panels have an aluminum frame around the panel perimeter, with mounting holes in the aluminum frame on the back of the panel. The actual dimensions of the panels vary from manufacturer to manufacturer. Some panels are rectangular, while others have a more-square aspect ratio. As a result, the location of the mounting holes varies depending on the manufacturer and the specific product. Thus, the designer of the mounting structure must also first know the exact model of panel to be used in order to design an appropriate mounting structure.

For mounting hardware manufacturers, this may require the design of many different mounting brackets, increasing the costs associated with tooling and inventory control. Alternatively, some support structure configurations use special “clips” to clip the solar panels onto supporting rails. The clips slide onto the rail and are positioned in between the panels to secure the edges of the panels to the support rail. This, however, requires that the clips be slid onto the rail from the ends of the rail. If a panel is defective and/or damaged and needs to be replaced, it is difficult to only remove a single panel. This type of mounting system also often requires extensive on-site placement, measurement, and adjustment on the part of the system installers. Moreover, these clips do not utilize the manufacturers' mounting holes, and therefore the installations may not meet the manufacturers' installation guidelines and/or invalidate warranties. Finally, conventional mounting systems require a large number of components, which increases the dollar value of inventory that must be carried by an installer in order to be prepared for any specific installation.

### BRIEF SUMMARY

The present invention is a clamp assembly for use in a solar panel mounting system for attaching one or more solar panels to a rooftop or other surface. The present invention is estimated to reduce rooftop labor by an installer by approximately eighty percent compared to conventional systems. The present invention also eliminates the need for mechanical bonding (grounding), which reduces the risk of fire and electrocution hazards. In addition, the present invention reduces the inventory of parts that must be carried by an installer by a factor of at least fifty.

The invention comprises a first bracket having a base, a width, a partially cylindrical surface spaced a distance from the base, and a cylindrical surface between the partially cylindrical surface and the base; and a second bracket having a U-shaped portion having a first leg, a second leg spaced a distance from the first leg, and a base connecting the first leg and the second leg, the U-shaped portion defining a first volume having a width greater than and corresponding to the width of the first bracket, a stem connected to the U-shaped portion and extending away from the first volume, and a bar connected to the stem and having a first planar surface and second planar surface defining first and second panel-receiving volumes.

### BRIEF DESCRIPTION OF THE DRAWINGS

FIG. 1 shows a solar panel array in use with an embodiment of the present invention.

FIG. 2 shows the rack of FIG. 1.

FIG. 3 is a section view of a tubing bracket of the embodiment in FIG. 1.

FIG. 4 shows tubing brackets of FIG. 3 installed on the rack of FIG. 2.

FIG. 5 is a section view of a panel bracket of the embodiment in FIG. 1.

FIG. 6-7 shows the panel bracket of FIG. 5 fastened to the tubing bracket of FIG. 3 on the rack of FIG. 1.

FIG. 8 shows solar panels installed between two adjacent panel brackets.

FIG. 9 is a section view of a floor mount tubing bracket of a second embodiment.

FIG. 10 shows the panel bracket of FIG. 5 fastened to the tubing bracket of FIG. 9.

FIG. 11 is a section view of another embodiment of a tubing bracket.

FIG. 12 shows the panel bracket of FIG. 5 fastened to the tubing bracket of FIG.

### DETAILED DESCRIPTION OF CERTAIN EMBODIMENTS

FIG. 1 shows a solar panel array 20 installed in a field. The array 20 includes a number of solar panels 22 supported by a rack 24 above the ground.

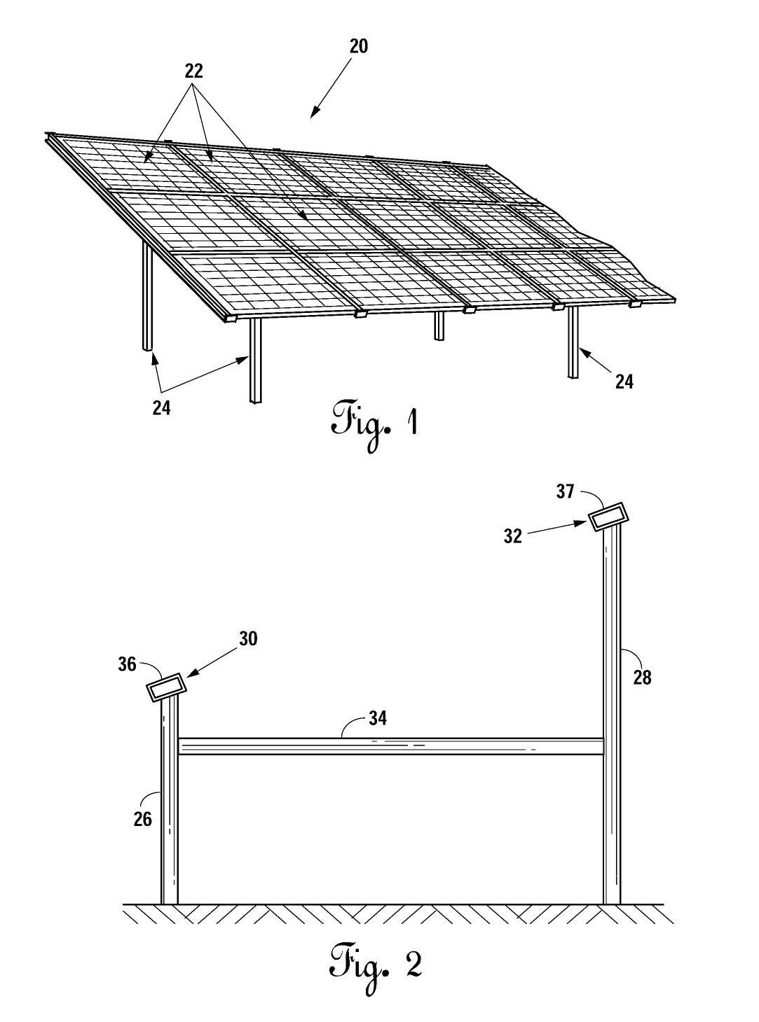

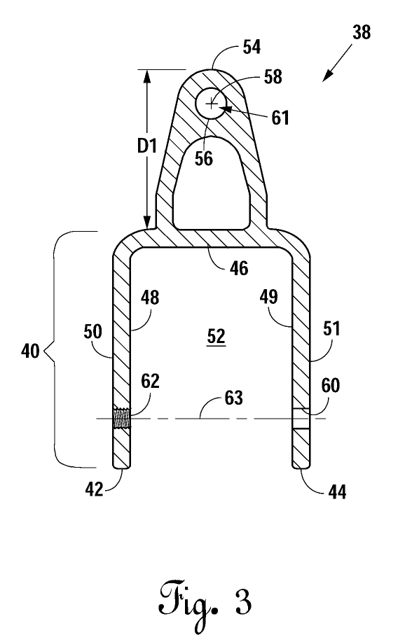

FIG. 2 shows the rack 24 of FIG. 1 in more detail and with the solar panels removed. The rack 24 comprises a number of short posts 26 and long posts 28 embedded in concrete or rock to provide stability and support the panels above the ground surface. A first horizontal rail 30 is attached to the top of each of the short posts 26. A second horizontal rail 32 is attached to the top of the long posts 28. Each short post 26 is connected to a long post 28 with a square-tubing tie 34 that runs perpendicular to the rails 30, 32. The first and second rails 30, 32 each have a rectangular profile and elongate planar top surface 36, 37, with the top surfaces 36, 37 being coplanar with one another. The difference in length between the short posts 26 and long posts 28 determines the angle of inclination of the panels relative to the ground surface.

Referring to FIG. 3, an aluminum tubing bracket 38 includes a U-shaped portion 40 that has first and second parallel legs 42, 44. A base 46 extends between and is connected to the legs 42, 44. Each leg 42, 44 has an inner surface 48, 49 and an outer surface 50, 51. The legs 42, 44 and base 46 define a generally cuboid volume 52. A partially cylindrical convex surface 54 is spaced a distance D1 from the base 46. A concave cylindrical surface 56 is between the volume 52 and the partially cylindrical surface 54. The concave cylindrical surface 56 defines a cylindrical hole 61 extending through the tubing bracket 38. The partially cylindrical surface 54, cylindrical surface 56, and hole 61 are concentric about a cylindrical axis 58. A cylindrical surface 60 extends through the second leg 44 to define a hole between the inner and outer surfaces 49, 51. A threaded surface 62 defines a generally cylindrical hole through the first leg 42 that is axially aligned with the first hole. The axis 63 of the first and second holes is transverse to the axis 58 of the cylindrical surface 56.

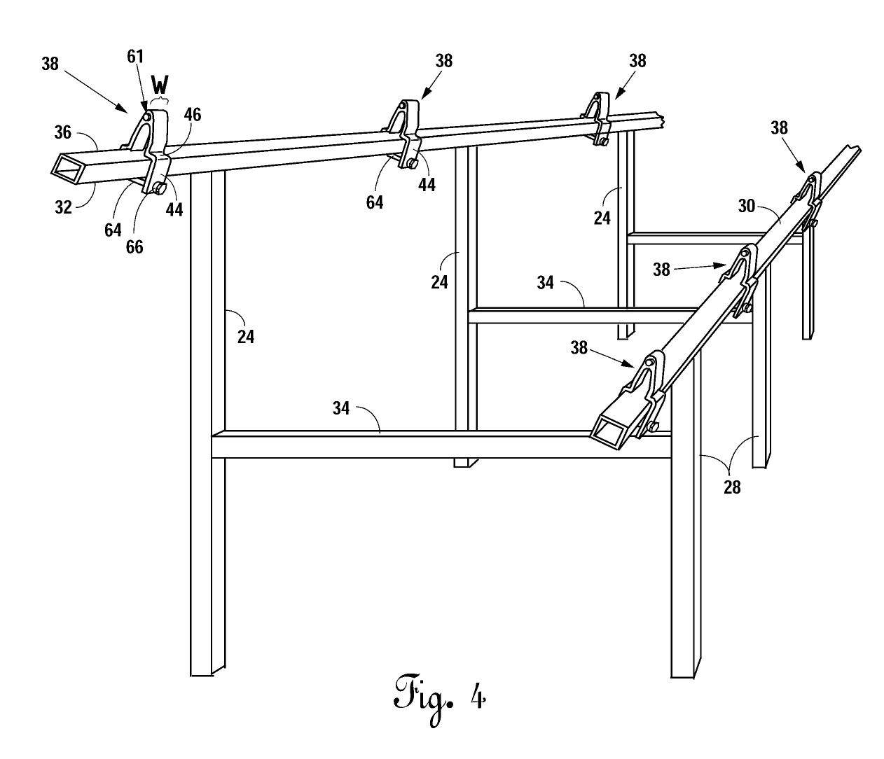

Referring to FIG. 4, a number of identical tubing brackets 38 of width W are fastened to the rails 30, 32 of the rack 24. Each bracket 38 on the first rail 30 is aligned with a corresponding bracket 38 on the second rail 32. The distance between the legs 42 (not shown), 44 is slightly larger than the distance between opposing sides of the rails 30, 32 to minimize movement of the bracket 38 relative thereto. Each leg 42, 44 contacts the rail. The base 46 is in contact with the top surface 36 of the rail 30 and the top surface 37 of rail 32. A bolt 64 is positioned in the first hole and threadedly engaged with the second hole (not shown). The bolt 64 is below the rails 30, 32. A washer 66 separates the head of the bolt 64 from the leg 44.

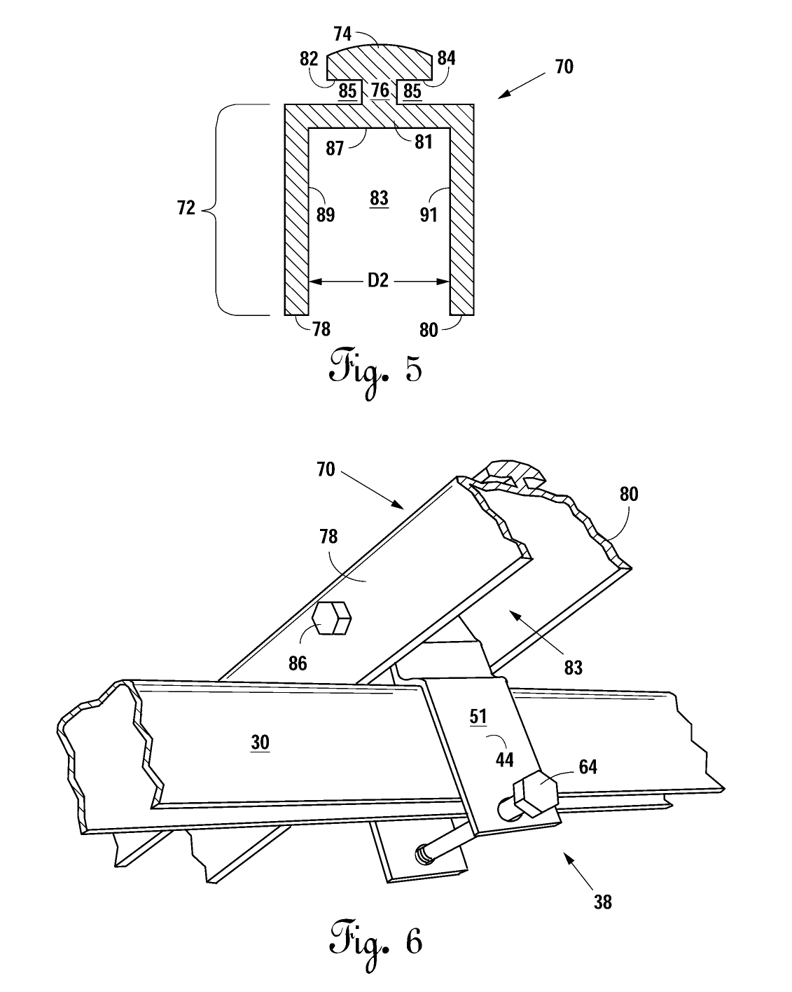

Referring to FIG. 5, an aluminum panel bracket 70 has a square-U shaped portion 72 and a bar 74 spaced a distance from the U-shaped portion 72. A stem 76 connects the bar 74 with a base 81. The U-shaped portion 72 has first and second parallel legs 78, 80 spaced apart a distance D2, which is slightly greater than the width of the tubing bracket 38 described with reference to FIG. 3. The base 81 connects to an end of each leg 78, 80. The base 81 has a planar inside surface 87. The first leg 78 has a planar inside surface 89. The second leg 80 has a planar inside surface 91. The base 81 and legs 78, 90 define a cuboid volume 83.

The bar 74 has first and second elongate planar surfaces 82, 84 adjacent to and on either side of the stem 76 and spaced a distanced from the base 81. The base 81, planar surfaces 82, 84, and the stem 76 jointly define elongate cuboid panel receiving volumes 85. The length of the panel bracket 70 may vary from application to application. Moreover, multiple panel brackets 70 may be placed end to end.

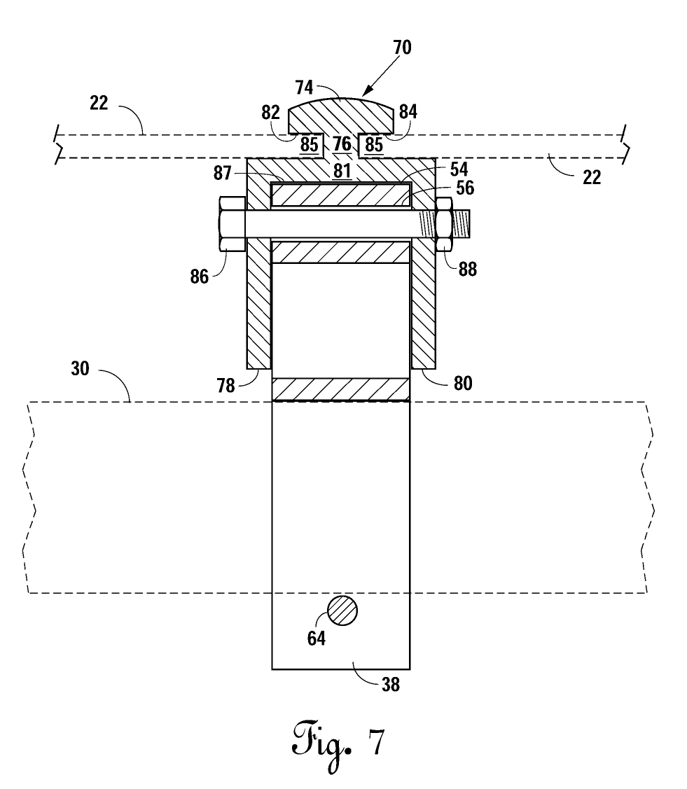

FIGS. 6-7 show a panel bracket 70 fastened to the tubing bracket 38 shown in FIG. 4. A bolt 86 extends through the first leg 78 of the panel bracket 70 and through the cylindrical hole 61 (see FIG. 3) of the tubing bracket 38, and is threadedly engaged with a nut 88 on the opposing side.

Referring specifically to FIG. 7, the partially cylindrical surface 54 of the tubing bracket 38 is in contact with, and supports, the panel bracket 70. Specifically, the surface 54 contacts the inner surface 87 of the base 81.

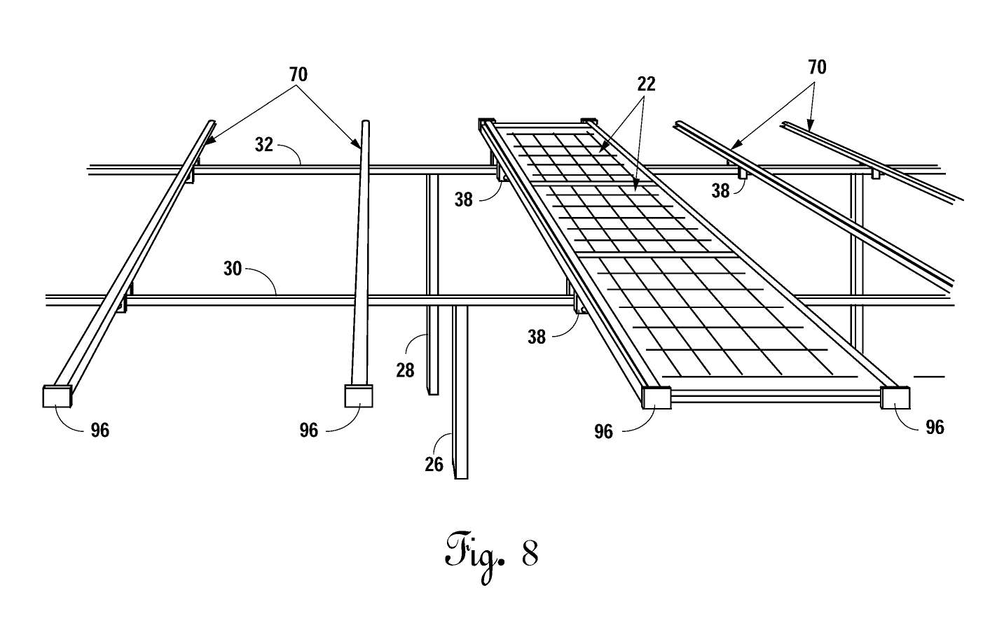

Referring to FIG. 8, one-eighth inch thick rectangular end plates 96 are attached (e.g., welded, bolted) to ends of the panel brackets 70. The panels 22 may be inserted into the panel receiving volumes 85 (see FIG. 7) at the opposing end and then slid toward the end plates 96, with the lowest panel resting against the end plates 96 of adjacent panel brackets 70.

FIG. 9 shows an aluminum wall/floor mount tubing bracket 100 that may be used for mounting solar panels on the roof of a structure or another generally planar support surface. The bracket 100 has first and second parallel legs 102, 104. A base 106 extends between, is connected to, and extends past the legs 102, 104. The base 106 has a top surface 108 and a bottom surface 110. A partially cylindrical convex surface 112 is spaced a distance D from the top surface 108 of the base 106. A concave cylindrical surface 114 is longitudinally between the top surface 108 and the partially cylindrical surface 112. The partially cylindrical surface 112 and cylindrical surface 114 are concentric about a cylindrical axis 116.

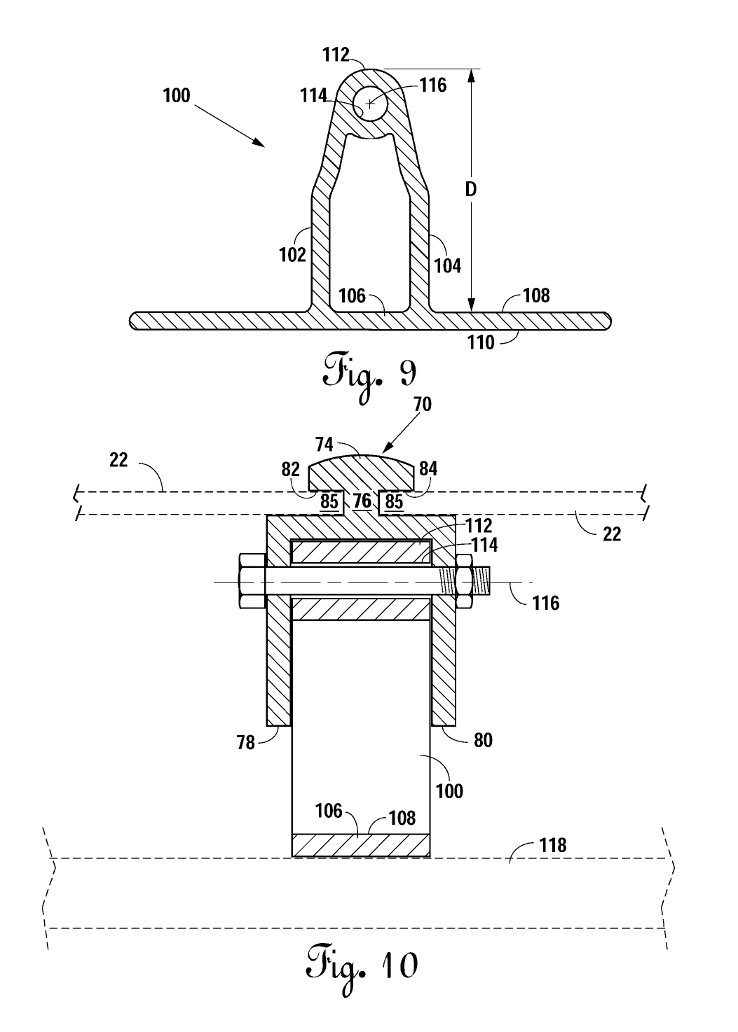

Referring to FIG. 10, the floor mount tubing bracket 100 connects to the panel bracket 70 as described with reference to FIG. 7. Moreover, multiple tubing brackets 100 may be connected at various angles relative to the panel bracket without requiring adjustment. The bracket 100 is connected to the roof 118 or other surface with lag screws or other fastening devices.

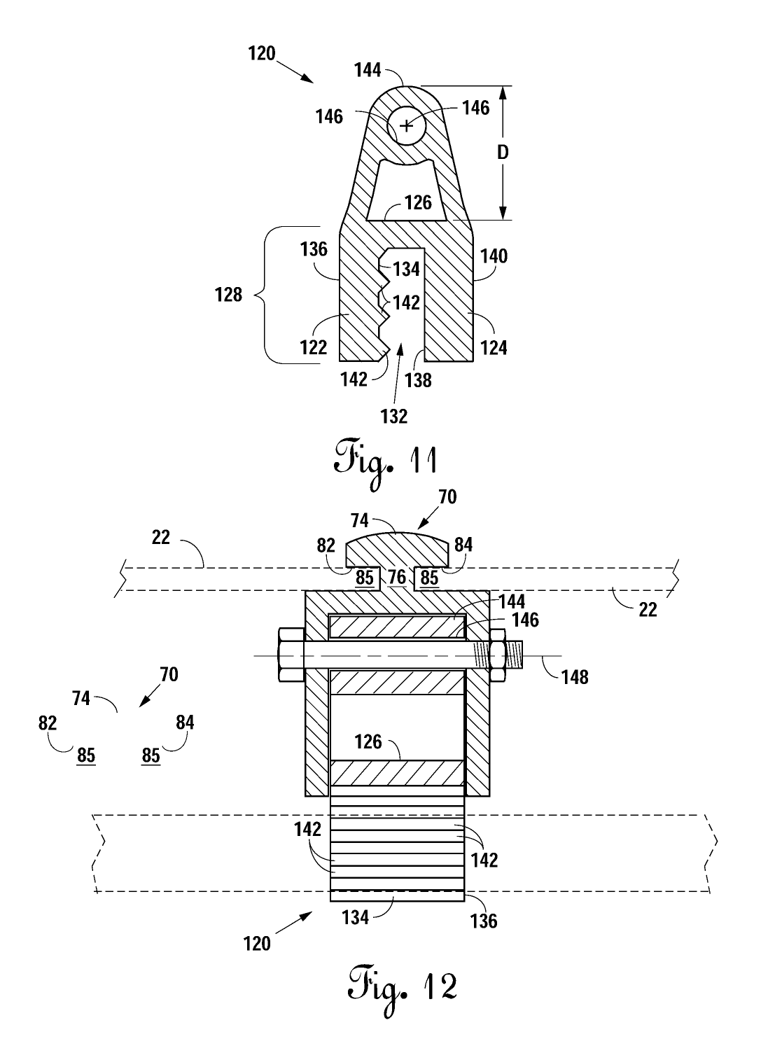

FIG. 11 shows another embodiment 120 of a tubing bracket. The embodiment 120 has first and second parallel legs 122, 124 connected to a base 126 to define a generally U-shaped portion 128 with a volume 132. The first leg 122 has a first inner surface 134 and an outer surface 136. The second leg 124 has a planar inner surface 138 and an outer surface 140. The first inner surface 134 defines three elongate ridges 142. A partially cylindrical surface 144 is spaced a distance D from the base 126. A concave cylindrical surface 146 is longitudinally between the volume 132 and the partially cylindrical surface 144. The partially cylindrical surface 144 and cylindrical surface 146 are concentric about a cylindrical axis 148.

FIG. 12 shows the connection of the tubing bracket 120 to the panel bracket 70 described with reference to FIG. 3. The tubing bracket 120 is connected to a rail having the same cross sectional profile as the volume 132.

The present invention is described in terms of specifically-described embodiments. Those skilled in the art will recognize that other embodiments of such system can be used in carrying out the present invention. Other aspects and advantages of the present invention may be obtained from a study of this disclosure and the drawings, along with the appended claims.

I claim:

1. A solar panel mounting system comprising:
a first bracket having a base, a width, a partially cylindrical surface spaced a distance from the base, and a cylindrical surface between the partially cylindrical surface and the base; and
a second bracket having a first leg, a second leg spaced a distance from the first leg, and a base connecting the first leg and the second leg, the first leg, second leg and base defining a first volume having a width greater than and corresponding to the width of the first bracket, a stem connected to the base and extending away from the first volume, and a bar connected to the stem and having a first planar surface and second planar surface defining first and second volumes between the bar and the base.

2. The solar panel mounting system of claim 1 further comprising the first bracket at least partially occupying the first volume of the second bracket.

3. The solar panel mounting system of claim 2 further comprising a bolt extending through the first leg and the second leg of the second bracket and the hole defined by the cylindrical surface of the first bracket.

4. The solar panel mounting system of claim 2 wherein the base of the second bracket is in contact with the partially cylindrical surface of the first bracket.
